(19) United States
(12) Patent Application Publication
(10) Pub. No.: US 2015/0201309 A1
(43) Pub. Date: Jul. 16, 2015

(54) SYSTEM AND METHOD FOR WIRELESS POSITIONING AND LOCATION DETERMINATION

(71) Applicant: Board of Trustees of Northern Illinois University, Dekalb, IL (US)

(72) Inventor: Lichuan Liu, Dekalb, IL (US)

(21) Appl. No.: 14/668,620

(22) Filed: Mar. 25, 2015

Related U.S. Application Data
(63) Continuation-in-part of application No. 12/483,317, filed on Jun. 12, 2009.
(60) Provisional application No. 61/060,897, filed on Jun. 12, 2008.

(51) Int. Cl. H04W 4/02

(52) U.S. Cl. CPC H04W 4/025

(57) ABSTRACT

A system and method for wireless sensor networks (WSN) positioning that is cost-effective, scalable, can be easily implemented, and provides improved performance and accuracy. A plurality of reference nodes with known locations transmit linear frequency modulation continuous waves (FMCW), while sensor nodes receive these waves and calculate the range difference among them based on the time frequency difference arrival (TFDA). The location information of the sensor nodes is obtained through the solving of a set of hyperbolic equations. Multidimensional scaling may be used or hybrid optimizing algorithm (HOA) processing to combine steepest-descent processing with Taylor series expansion to increase accuracy.

### RELATED APPLICATIONS

The present application is a Continuation-In-Part of copending U.S. patent application Ser. No. 12/483,317, filed Jun. 12, 2009, and titled “System and Method for Wireless Position and Location Determination,” which claims the benefit of priority under 35 U.S.C. §119(e) to U.S. Provisional Application No. 61/060,897, filed Jun. 12, 2008. The disclosures set forth in the referenced applications are incorporated herein by reference in their entireties.

### FIELD OF THE DISCLOSURE

The disclosure generally relates to the field of wireless sensor networks. Specifically, the disclosure relates to the areas of wireless positioning and location determination.

### BACKGROUND

Wireless sensor networks (WSN) have gathered attention recently due to their wide applications in both military and civilian areas (e.g., environmental monitoring and protection, tragedy rescue, wild animal protection, etc.). Positioning is a key factor for these important applications. Receiving data from a node without the node's location information is not particularly useful and sometimes useless. Moreover, the availability to determine a wireless node's position information enables more efficient protocols and routing algorithms. Position-based routing has several advantages over node-based and data-based routing, such as: no need to maintain routing tables, and good resilience to mobility.

There are two general approaches to localization: (1) coarse-grained localization, using minimal information, and (2) fine-grained localization, using detailed information. In the case of coarse-grained localization, the minimal information could be binary proximity (i.e., if one node can hear another), or cardinal direction information (in a set of nodes, which one is the closest to a given node). With such information, the broad location of a node can be obtained. Approaches in this class include: binary proximity, centroid calculation, geometric constraints, approximate point in triangle, and identifying code construction (ID-CODE) algorithm. These approaches require lower network resources and have lower cost because only minimal information is required. However, the primary drawback is that less accurate information results.

Although a Global Positioning System (GPS) can provide a receiver's absolute coordinates, this positioning service is available only when at least four satellites are visible. GPS positioning techniques cannot be well utilized in many environments, such as indoors, urban areas with tall buildings, tunnels, or forests. Even when receiver nodes are deployed in GPS friendly conditions, there are drawbacks related to power, size and cost that may make the solution undesirable. Sensor nodes can be very small, for example, wearable sensors. Thus, it may be difficult to integrate GPS receivers into sensor nodes whose power, physical size and cost are highly limited. Moreover, political considerations may affect the availability of GPS signals due to external factors. For example, the Selective Availability (SA) policy can dramatically decrease GPS' positioning accuracy.

Technically, in a GPS system, the GPS receiver needs to demodulate the received satellite signals first, and then it uses coarse-acquisition (C/A) Gold code to separate them, known as C/A decoding. The receiver also obtains the signal receiving time from its local clock. After decoding, the receiver calculates the sending time of the signal from each satellite, which takes two steps: (1) the receiver uses the C/A Gold code with the same pseudo-random number sequence as the satellite's to compute an offset that generates the best correlation. This process is repeated until a correlation peak appears or all 1023 possible cases have been tried. If all 1023 cases have been tried without valid correlation, the frequency oscillator is offset to the next value and the process is repeated, and (2) the receiver begins reading the satellite broadcasting navigation message (including almanac, ephemeris parameters, etc.). After being read and interpreted, the sending time embedded in the message can be acquired. At this time, the receiver can obtain one time of arrival (TOA) by computing hardware and software using a GPS receiver.

The most common fine-grained positioning technologies include: received signal strength (RSS), angle of arrival (AOA), TOA, and time difference of arrival (TDOA). The RSS method measures the received signal's power which may change if the environment is changing. In WSN with a time-varying channel, the measured results are not reliable. Thus, the position information obtained based on RSS is imprecise. The AOA approach relies on an antenna array for determining the angle of an arrival signal. Therefore, no such option exists for small size sensors with single antenna setting. The TOA method measures the signal arrival time, which is used by the GPS positioning calculation. Its fine synchronization is the key component that determines the positioning resolution. TDOA is widely used for cell phone positioning applications such as E911. This method also requires the time synchronization among different stations, which is available in cellular networks. However, this requirement is difficult to satisfy for sensor nodes with limited communication and computational abilities. Therefore, there exists the need for a highly-precise position method with limited synchronization requirements.

### SUMMARY

The present disclosure provides a system and method for wireless sensor networks (WSN) positioning which is cost-effective, scalable, can be easily implemented, and provides excellent performance and accuracy. In the present disclosure, a few reference nodes with known locations transmit linear frequency modulation continuous waves (FMCW), while sensor nodes receive these waves and calculate the range difference among them based on the time frequency difference arrival (TFDA). The location information of the sensor nodes is obtained through the solving of a set of hyperbolic equations. This technique is cost-efficient, scalable and can be easily implemented.

Accordingly, the disclosed embodiments provide an apparatus, system and method of improving the manufacture of laser projection modules and devices. These embodiments may provide functional improvement over the known art, and may provide other advantageous features that will be made more apparent from the Detailed Description, below.

### BRIEF DESCRIPTION OF THE FIGURES

The present disclosure will become more fully understood from the detailed description given herein below and the accompanying drawings which are given by way of illustration only, and which thus do not limit the present disclosure, and wherein:

FIG. 1 is a diagram depicting the relationship between reference nodes (RN) and general sensor nodes (GN), according to an embodiment;

FIG. 2 shows position detection based on FDOA utilizing three reference nodes with prior position knowledge for general node estimation of its own position based on FDOA;

FIG. 3 is a block diagram illustrating a TFDA configuration under an illustrative embodiment.

FIG. 4 shows a simulated waveform diagram for transmitted signals received at a general node from four different reference nodes under an illustrative embodiment;

FIG. 5 shows a simulated diagram under an illustrative embodiment showing a cumulative distribution function versus error for steepest decsent, Taylor series and HOA (Steepest+Taylor) for three reference nodes.

FIG. 6 shows a simulated diagram under an illustrative embodiment showing a cumulative distribution function versus error for steepest descent, Taylor series and HOA (Steepest+Taylor) for four reference nodes.

FIG. 7 shows a simulated sensor node network comprising randomly placed sensor nodes and a plurality of anchor nodes under an illustrative embodiment; and

FIG. 8 shows a simulated sensor node network having relative positions of sensor nodes identified for a plurality of anchor nodes.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Illustrative embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that illustrative embodiments may be embodied in different forms. As such, the illustrative embodiments should not be construed to limit the scope of the disclosure. In some illustrative embodiments, well-known processes, well-known device structures, and well-known technologies may not be described in detail.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the illustrative embodiments.

Furthermore, it should be appreciated by those skilled in the art that, while certain illustrations and disclosures herein may provide specific numbers, values, dimensions and/or ranges, they are provided merely for the purposes of illustration only, and are not intended to be limiting, and that any suitable alternate and/or additional numbers, values, dimensions and/or ranges may be used for other applications without deviating from the scope of the present disclosure.

In wireless sensor networks (WSN), location information acquisition is critical to ensure network performance and efficiency. The present disclosure provides a new WSN positioning system and method which is cost-effective, scalable, can be easily implemented, and provides excellent performance and accuracy. In the present disclosure, a few reference nodes with known locations transmit linear frequency modulation continuous waves (FMCW), while other sensor nodes receive these waves and calculate the range difference among them based on the time frequency difference arrival (TFDA). The location information of the sensor nodes is obtained through the solving of a set of hyperbolic equations. This technique is cost-efficient, scalable and can be easily implemented.

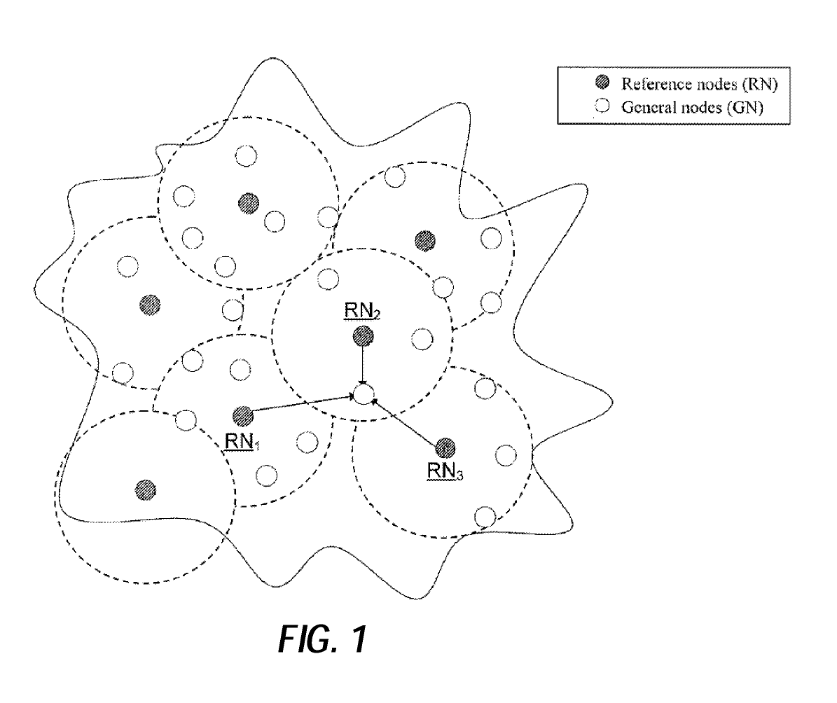

Under illustrative embodiments, wireless sensor networks are disclosed that may be deployed in a predetermined area. FIG. 1 depicts a small proportion of devices, known as reference nodes (RN) (1), which have a priori information regarding their coordinates. These RNs are equipped with computer processing devices including one or more processors, memory, GPS receivers (including hardware and software) or alternatively, global reference systems, such as accelerometers, compasses and gyros in order to obtain their own position information. They have transmitters which can transmit sensing data, control information and the linear FMCW signals as well. They also have receivers which can be used to receive data or information. Other nodes known as general nodes (GN) (2) may be equipped similarly to the RNs, but do not know their positions in advance in one example. These GNs do not need the positioning equipment, such as GPS or gyro, as they determine their own locations using the techniques disclosed herein. In some illustrative embodiments, the GNs may have transmitters and receivers for transmitting and receiving sensing data and control information, and they can also receive linear FMCW signals from RNs. It should be noted that the general nodes of the present disclosure can also transmit and become reference nodes once their position has been determined. Thus, the present disclosure's accuracy continues to improve as the positions of more general nodes are determined.

In an illustrative embodiment, the reference nodes are equipped with GPS receivers or, alternatively, global reference systems, such as accelerometers, compasses and gyros in order to obtain their own position information. These reference nodes have perfect synchronization with each other. Furthermore, in the illustrative embodiment, each RN has a unique identification (ID), and they are orthogonal to each other, ensuring their synchronization. The reference nodes broadcast their IDs, location information, and linear FM signals (also called chirp signals) to their neighbors simultaneously, under illustrative embodiments. The general sensor nodes (GN) in turn receive the chirp signals transmitted by the RNs. A general node can receive several chirp signals from different reference nodes at the same time.

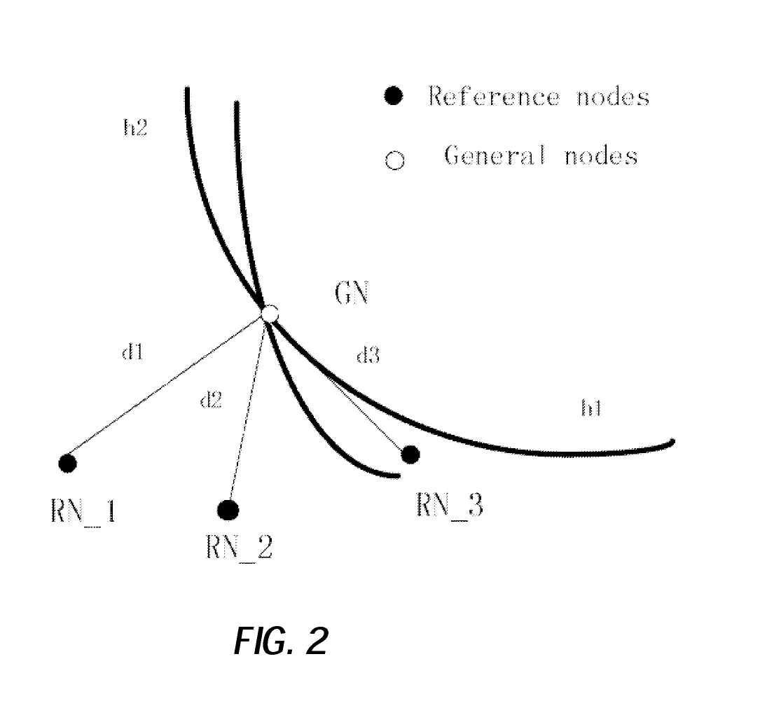

Upon receiving these chirp signals, a GN then obtains the frequency difference between two (or more) received chirp signals by mixing the various received signals. In the preferred embodiment, this is accomplished by taking the frequency difference between the frequencies, multiplying it by the speed of light, and then dividing it by the sweeping bandwidth. Based on the information of several RN nodes' position and the range differences among them, the GN is then capable of calculating its own location accurately, as described below. In one embodiment of the present disclosure, the GN obtains the two range differences among three RNs, thereby determining two hyperbolic equations (h1, h2) as illustrated in FIG. 2. The GN may then solve the set of hyperbolic equations (h1, h2), which identifies the intersection of the two hyperbolic lines, thereby allowing the GN to estimate its own 2-dimensional location accurately based at least in part from d1, d2, d3 in the example of FIG. 2.

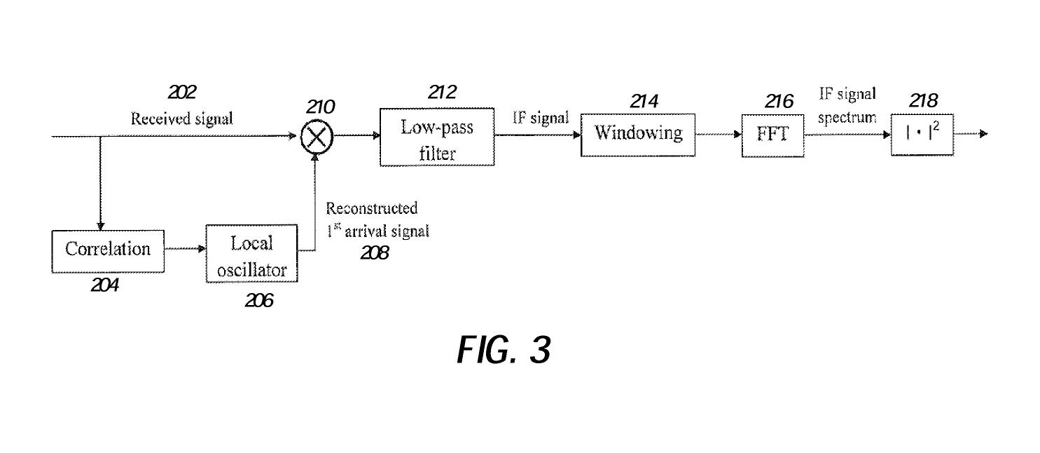

FIG. 3 shows an illustrative TDMA configuration under an embodiment, utilizing a mixer 210 and a low pass filter 212, together with a GN processor configured for windowing 214, signal transformation 216 (e.g., FFT) and magnitude square calculating 218. Here, a GN may receive linear FMCW signals (202) from M different neighboring RNs, where a correlation (204-208) may be performed in a processing device of the GN to extract the first arrival linear FMCW signal from its nearest RN (which may be the one with the strongest power). The first arrival signal may be used to mix (210) the received signal that may include several linear FMCW signals from RNs. A low-pass filter 212 may then be used to remove the high frequency components and let intermediate frequencies (IF) (e.g., the frequency difference) pass. As frequency differences may be proportional to range differences, the GN may obtain the range differences from two RNs that may define one hyperbolic relationship. In the case where range differences from one GN to a plurality of different RNs are the same, the may define a straight-line relationship. With the information of a plurality (M) of RN positions and the range differences (M−1) to each pair of them, the GM may estimate its own 3D location accurately by solving for a set of hyperbolic equations relating to the relationship.

After windowing 214 is performed on the IF signal via the processing device of GN, the signal's power spectrum is calculated by using a transformation function, such as a Fast Fourier Transform (FFT) algorithm. Accordingly, the frequency differences among the first arrival signal and others may be obtained. Once the GN calculates TFDAs and the location of the RNs, it can calculate its own position by solving a set of hyperbolic equations. In certain embodiment, where the GN hears three RNs with the same distance, the GN may use the identification (ID) of the RNs to estimate its own location by calculating a centroid of the triangle determined by the three RNs.

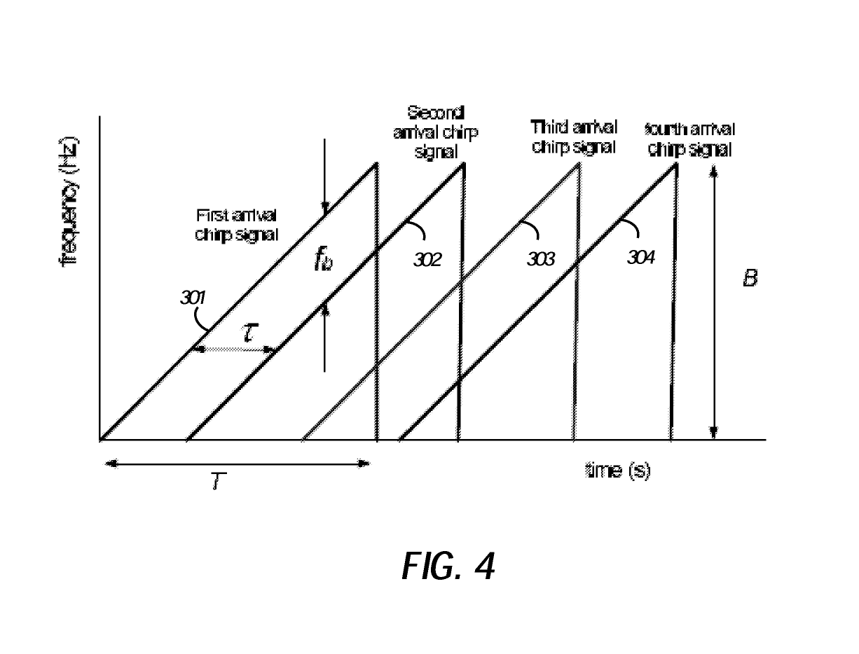

FIG. 4 shows a simulated waveform of a GN having received a plurality of different RN signals 301-304, having a travel time difference τ of τ_{2,1} and τ_{3,1}, and the bandwidth of the transmitted signal being B and the sweep time being T. In a linear FMCW case, two of the FMCW signals may be mixed together (210) and filtered via low-pass filter 212 to produce a superimposition of difference frequencies. In the embodiment of FIG. 4, the plurality of received signals may be multiplied in the mixer 210, where, after low-pass filtering in 212, only the difference is left. Accordingly, the TFDA for the signal may be expressed as f_{d}, where

$${f}_{{d}_{i , 1}} = \frac{B {τ}_{i , 1}}{T} ,$$

with i=2, 3 and 4
The time difference of arrival and the distance (range) difference, R_{i,1}, may be related as follows:

R_{i,1}=cτ_{i,1}, with i=2,3 and 4

where c is the speed of light. The range difference R_{i,1} may be obtained from

$${R}_{i , 1} = c {τ}_{i , 1} = c \cdot \frac{{f}_{{d}_{i , 1}} T}{B}$$

and the range difference resolution is

$$Δ R = \frac{c}{2 B} .$$

If the bandwidth is wide enough, ΔR may be small. Compared to conventional ranging techniques, it can be appreciated by those skilled in the art that high-range resolution may be obtained. In some illustrative embodiments, all received signals may be used to obtain TFDAs by applying a transformation (e.g., FFT) concurrently, where the multiple range differences may be used for positioning.

In embodiments where TFDA is used for a 2-dimensional positioning calculation, a GN may be positioned in an unknown coordinate (x, y) in a WSN. Assuming the GN can receive signals (M) from a plurality of RNs (e.g., M≧3), the distance from the node to an i^{th} reference node may be determined by

Rᵢ=\sqrt{(Xᵢ−x)²+(Yᵢ−y)²}i=1,2, . . . , M

where Xᵢ and Yᵢ are known coordinates of RNᵢ.

Accordingly, the range difference between the node RNᵢ and RN₁ may be determined from

$$\begin{matrix}{R}_{i , 1} = {R}_{i} - {R}_{1} \\ = \sqrt{{( {X}_{i} - x )}^{2} + {( {Y}_{i} - y )}^{2}} - \sqrt{{( {X}_{1} - x )}^{2} + {( {Y}_{1} - y )}^{2}}\end{matrix} \qquad ( 4 )$$

where R1 is a range between RN1 and the GN. This may define a set of nonlinear hyperbolic equations whose solution may provide a 2-D coordinate of an unknown node.

In embodiments where TFDA is used for a 3-dimensional positioning calculation, a GN may be positioned in an unknown coordinate (x, y, z) in a WSN. Assuming the GN can receive signals (M) from a plurality of RNs (e.g., M≧4), the distance from the node to an i^{th} reference node may be determined by

Rᵢ=\sqrt{(Xᵢ−x)²+(Yᵢ−y)²+(Zᵢ−z)²}i=1,2, . . . , M (1)

where Xᵢ, Yᵢ and Zᵢ are the known coordinates of RNᵢ. The Range difference between this node to RNᵢ and RN₁ may be expressed as

$$\begin{matrix}{R}_{i , 1} = {R}_{i} - {R}_{1} \\ = \sqrt{{( {X}_{i} - x )}^{2} + {( {Y}_{i} - y )}^{2} + {( {Z}_{1} - z )}^{2}} - \\ \sqrt{{( {X}_{1} - x )}^{2} + {( {Y}_{1} - y )}^{2} + {( {Z}_{1} - z )}^{2}}\end{matrix} \qquad ( 2 )$$

where R₁ is the range between RN₁ and the GN. This may define a set of non-linear hyperbolic equations whose solution may prove 3-D coordinates of an unknown node.

When GN location processing involves four or more RNs, an iterative Taylor-series technique may be used for solving the hyperbolic equations in some illustrative embodiments. Using initial coordinate values (x₀, y₀, z₀), the estimate at each iteration may be calculated by determining a local linear least-square (LS) solution as deviations. Using the range difference of equation (2) above, taking a partial derivative of x and y on both sides results in

$$Δ {R}_{i , 1} = ( \frac{{X}_{1} - x}{{R}_{1}} - \frac{{X}_{i} - x}{{R}_{i}} ) Δ x + ( \frac{{Y}_{1} - y}{{R}_{1}} - \frac{{Y}_{i} - y}{{R}_{i}} ) Δ y + ( \frac{{Z}_{1} - z}{{R}_{1}} - \frac{{Z}_{i} - z}{{R}_{i}} ) Δ z .$$

Where Rᵢ may be calculated using equation (1) when x=x₀, y=y₀ and z=z₀, i.e.,

Rᵢ=\sqrt{(Xᵢ−x₀)²+(Yᵢ−y₀)²+(Zᵢ−z₀)²}

Next, a set of linearized hyperbolic equations may be obtained from

$$\underbrace{[ \begin{matrix}Δ {R}_{2 , 1} \\ Δ {R}_{3 , 1} \\ ⋮ \\ Δ {R}_{M , 1}\end{matrix} ]}_{h} = \underbrace{[ \begin{matrix}\frac{{X}_{1} - x}{{R}_{1}} - \frac{{X}_{2} - x}{{R}_{2}} & \frac{{Y}_{1} - y}{{R}_{1}} - \frac{{Y}_{2} - y}{{R}_{2}} & \frac{{Z}_{1} - z}{{R}_{1}} - \frac{{Z}_{2} - z}{{R}_{2}} \\ \frac{{X}_{1} - x}{{R}_{1}} - \frac{{X}_{3} - x}{{R}_{3}} & \frac{{Y}_{1} - y}{{R}_{1}} - \frac{{Y}_{3} - y}{{R}_{3}} & \frac{{Z}_{1} - z}{{R}_{1}} - \frac{{Z}_{3} - z}{{R}_{3}} \\ ⋮ & ⋮ & ⋮ \\ \frac{{X}_{1} - x}{{R}_{1}} - \frac{{X}_{M} - x}{{R}_{M}} & \frac{{Y}_{1} - y}{{R}_{1}} - \frac{{Y}_{M} - y}{{R}_{M}} & \frac{{Z}_{1} - z}{{R}_{1}} - \frac{{Z}_{M} - z}{{R}_{2}}\end{matrix} ]}_{G} [ \begin{matrix}Δ x \\ Δ y \\ Δz\end{matrix} ] \qquad ( 3 )$$

where the LS solution for the equation is when M≧4, or

[ΔxΔΔzy]^{T}=(G^{T}G)⁻¹G^{T}h

If the covariance matrix of the TFDA is known, the LS solution to (3) may be

[ΔxΔΔzy]^{T}=(G^{T}G)⁻¹G^{T}h

where C is the covariance matrix of the estimated TFDAs. In a subsequent iteration, x₀, y₀ and z₀ may be set to x=x₀+Δx, to y=y₀+Δy, and to z=z₀+Δz. This process may be repeated until the resultant deviation is small enough to be below a given threshold. It can be appreciated by those skilled in the art that the Taylor method is robust enough to provide accurate location results and further use the redundant measurements to improve the positioning calculation.

In some illustrative embodiments, a plurality of analytical methods may be used to solve for non-linear hyperbolic equation sets. For example, in a four-RN case, it may be assumed that RN₄ is at an origin coordinate (X₄, Y₄, Z₄)=(0, 0, 0) while the others are at (X₁, Y₁, Z₁), (X₂, Y₂, Z₂), and (X₃, Y₃, Z₃). From this, the following determination may be made

$$[ \begin{matrix}{R}_{2 , 1}^{2} - {K}_{2} + {K}_{1} \\ {R}_{3 , 1}^{2} - {K}_{3} + {K}_{1} \\ {R}_{4 , 1}^{2} - {K}_{2} + {K}_{1}\end{matrix} ] - 2 {( {x}^{2} + {y}^{2} + {z}^{2} )}^{1 / 2} [ \begin{matrix}{R}_{2 , 1} \\ {R}_{3 , 1} \\ {R}_{4 , 1}\end{matrix} ] = 2 [ \begin{matrix}{X}_{2 , 1} & {Y}_{2 , 1} & {Z}_{2 , 1} \\ {X}_{3 , 1} & {Y}_{3 , 1} & {Z}_{3 , 1} \\ {X}_{4 , 1} & {Y}_{4 , 1} & {Z}_{4 , 1}\end{matrix} ] [ \begin{matrix}x \\ y \\ z\end{matrix} ] \\ where {K}_{1} = {X}_{1}^{2} + {Y}_{1}^{2} + {Z}_{1}^{2} , \\ {K}_{2} = {X}_{2}^{2} + {Y}_{2}^{2} + {Z}_{2}^{2} , \\ {K}_{3} = {X}_{3}^{2} + {Y}_{3}^{2} + {Z}_{3}^{2} , and \\ {K}_{4} = {X}_{4}^{2} + {Y}_{4}^{2} + {Z}_{4}^{2} . \qquad ( 4 )$$

Accordingly, equation (4) may be expressed as

$$b - 2 Rd = 2 Ax \\ where b = [ \begin{matrix}{R}_{2 , 1}^{2} - {K}_{2} + {K}_{1} \\ {R}_{3 , 1}^{2} - {K}_{3} + {K}_{1} \\ {R}_{4 , 1}^{2} - {K}_{4} + {K}_{1}\end{matrix} ] - 2 {( {x}^{2} + {y}^{2} + {z}^{2} )}^{1 / 2} [ \begin{matrix}{R}_{2 , 1} \\ {R}_{3 , 1} \\ {R}_{4 , 1}\end{matrix} ] , \\ d = [ \begin{matrix}{R}_{2 , 1} \\ {R}_{3 , 1} \\ {R}_{4 , 1}\end{matrix} ] , x = [ \begin{matrix}x \\ y \\ z\end{matrix} ] , and R = {( {x}^{2} + {y}^{2} + {z}^{2} )}^{1 / 2} \qquad ( 5 )$$

is the radius of the GN and

$$A = [ \begin{matrix}{X}_{2 , 1} & {Y}_{2 , 1} & {Z}_{2 , 1} \\ {X}_{3 , 1} & {Y}_{3 , 1} & {Z}_{3 , 1} \\ {X}_{4 , 1} & {Y}_{4 , 1} & {Z}_{4 , 1}\end{matrix} ] .$$

In equation (5), the unknown (x, y, z) appears in both sides of the equation, the GN position x is on the right-hand side, and GN radius R on the left-hand side. If, under an illustrative embodiment, it is assumed that R is known, equation (5) may be expressed as

$$x = \frac{1}{2} {A}^{- 1} ( b - 2 Rd ) \qquad ( 6 )$$

R=(x^{T}x)^{1/2}, (7)

equation (5) may be inserted into equation (7) (with i=1) to produce a quadratic equation in terms of R, or

$$R = \frac{- b \pm \sqrt{{b}^{2} - 4 a c}}{2 a}$$

$$where$$

$$a = [ 4 - 4 {{d}^{T } ( {A}^{- 1} )}^{T} {A}^{- 1} d ] \\ b = [ 2 {{d}^{T} ( {A}^{- 1} )}^{T} {A}^{- 1} b + 2 {{b}^{T} ( {A}^{- 1} )}^{T} {A}^{- 1} d ]$$

$$c = [ 2 {{b}^{T} ( {A}^{- 1} )}^{T} {A}^{- 1} b ] .$$

One root may be selected from prior information, and a position of an RN may be obtained using equation (6). In some illustrative embodiments, when there is a five-RN case for example, a Taylor series iterative method may similarly be used.

In some illustrative embodiments, positioning techniques may be applied to a static wireless network in which the reference nodes are static. In one example, a positioning, referred to herein in some cases as a “hybrid optimizing algorithm” (HOA), may combine steepest-descent processing with Taylor series expansion. The steepest descent processing is advantageous in that it converges quickly at initial iterations, and has less computational complexity. The Taylor series processing may be applied on initial estimations. As will be disclosed in greater detail below, the HOA processing may achieve better performance on position accuracy.

Generally speaking, a Taylor series may be thought of as a representation of a function as an infinite sum of terms that are calculated from the values of the function's derivatives at a single point. A function may be approximated by using a finite number of terms of a Taylor series, where quantitative estimates on the error in this approximation may be provided as well. Typically, any finite number of initial terms of the Taylor series of a function is referred to as a Taylor polynomial. A Taylor series of a function may comprise the limit of that function's Taylor polynomials, provided that the limit exists. In certain cases, a function may not be equal to its Taylor series, even if its Taylor series converges at every point. In other cases, a function that is equal to its Taylor series in an open interval (or a disc in the complex plane) is known as an analytic function in that interval.

Steepest descent processing may use gradient vectors to minimize the estimation error and has the property of fast convergence when the initial estimate (guess) is far from the true value. By using this, an initial value may be determined that is close to the true value, after which Taylor series processing can be performed. Generally speaking, steepest descent (or “gradient descent”) may be a first-order optimization algorithm. To find a local minimum of a function using steepest descent, steps proportional to the negative of the gradient (or of the approximate gradient) of the function may be selected at a current point. If, instead, the steps proportional to the positive of the gradient are selected, this approaches a local maximum of that function (or “steepest descent”).

In an illustrative embodiment, a network (e.g., FIG. 1) may be configured where, for example, sensor nodes are randomly distributed in a predetermined area. The prior information of some of the nodes are known in advance known as Reference nodes (RN) and the other nodes are called as General nodes (GN) whose positions are to be determined. Networks with less number of RN's are available as they are equipped with GPS receivers or are by manually configuring location which is more cost effective. The references nodes are orthogonal to each other. By using Time Frequency Differential Arrival Method (TFDA) several RN's transmit a linear FM signals which is heard by a GN. By mixing these signals a GN can obtain a frequency difference signal which intern is proportional to the range difference. From a geometric perspective each of these equations represents a hyperbolic curve. Thus a GN can obtain its position by solving these hyperbolic equations.

The time frequency difference arrival (TFDA) is given by

$${f}_{{d}_{i , 1}} = \frac{B {Δτ}_{i}}{T} i = 2 , 3 ,$$

Where B is the Bandwidth, T is the sweep time, Δτᵢ is the time difference of arrival (TDOA). A relation between TDOA and range difference (R_{i,1}) may be expressed as

R_{i,1}=cΔτᵢ=c(tᵢ−t₁)=Rᵢ−R₁

where c is the speed of light, and

Rᵢ=\sqrt{(Xᵢ−x)²+(Yᵢ−y)²}, I=1,2, . . . , N.

Here, (Xᵢ, Yᵢ) represent an i^{th} position of the RN and (x,y) is the position of a GN which is to be estimated.

The range difference between the 1^{st} and i^{th} node of a RN may be determined by

fᵢ(x,y)=\sqrt{(x−Xᵢ₊₁)²+(y−Yᵢ₊₁)²}−\sqrt{(x−X₁)²+(y−Y₁)²}, i=1,2, . . . , N−1,

where (X₁,Y₁) are the 1^{st} RN's position. This equation can also be represented by

fᵢ(x,y)=d_{i+1,1}+ε_{i+1,1}, i=1,2, . . . , N−1 (8)

where d_{i+1,i}=c(tᵢ₊₁−tᵢ) and tᵢ's are the corresponding time of arrivals and ε_{i,1} are the corresponding range differences estimation error.

For solving these hyperbolic equations for the GN, a Taylor series expansion may be used which is an iterative method. In one example, an initial guess position of a GN may be at (x₀,y₀). As such, the coordinates and deviation may be determined by

x=x₀+δₓ, y=y₀+δ_{y},

where (x,y) are the original coordinates of a GN and δₓ, δ_{y} are the deviations also known as error of the original value from the guess value. Expanding the first two terms of the Taylor series expansion, the following may be obtained:

$$\begin{matrix}{f}_{i , 0} + {a}_{i , 1} {δ}_{x} + {a}_{i , 2} {δ}_{y} \approx {d}_{i + 1 , 1} + {ɛ}_{i + 1 , 1} , i = 1 , 2 , … , N - 1 , & ( 9 ) \\ where & \\ {f}_{i , 0} = {f}_{i} ( {x}_{0} , {y}_{0} ) \\ {a}_{i , 1} = \frac{\partial {f}_{i}}{\partial x} \vert ( {x}_{0} , {y}_{0} ) = \frac{{X}_{1} - {x}_{0}}{{d}_{1}} - \frac{{X}_{i + 1} - {x}_{0}}{{d}_{i + 1}} \\ {d}_{i} = \sqrt{{( {x}_{0} - {X}_{i} )}^{2} + {( {y}_{0} - {Y}_{i} )}^{2}} \\ {a}_{i , 2} = \frac{\partial {f}_{i}}{\partial x} \vert ( {x}_{0} , {y}_{0} ) = \frac{{Y}_{1} - {y}_{0}}{{d}_{1}} - \frac{{Y}_{i + 1} - {y}_{0}}{{d}_{i + 1}} & ( 10 )\end{matrix}$$

Reformulating equation (10), it can be determined that

$$A δ = D + e \\ where \\ A = [ \begin{matrix}{a}_{1 , 1} & {a}_{1 , 2} \\ {a}_{2 , 1} & {a}_{2 , 2} \\ ⋮ & ⋮ \\ {a}_{M - 1 , 1} & {a}_{M - 1 , 2}\end{matrix} ] , δ = [ \begin{matrix}{δ}_{x} \\ {δ}_{y}\end{matrix} ] \\ and \\ D = [ \begin{matrix}{d}_{2 , 1} - {f}_{1 , 0} \\ {d}_{3 , 1} - {f}_{2 , 0} \\ ⋮ \\ {d}_{M - 1 , 1} - {f}_{M - 1 , 0}\end{matrix} ] , e = [ \begin{matrix}{ɛ}_{2 , 1} \\ {ɛ}_{2 , 1} \\ ⋮ \\ {ɛ}_{M - 1 , 1}\end{matrix} ] \qquad ( 11 )$$

The least square estimator for Equation (11) would be

δ=[A^{T}A]⁻¹A^{T}D

If the covariance matrix of the TDFA is known then the least square estimator is given as:

δ=[A^{T}R⁻¹A]⁻¹A^{T}R⁻¹D

where R is the covariance matrix of the estimated TFDA's.

In the next iterations the value of x₀ and y₀ are replaced with the values of x and y from Equation (9). This process is repeated until the value of δ is reduced to a smaller or negligible number. A potential drawback of this embodiment is that it is dependent on initial iterations and may require high computational complexity. However, in some illustrative embodiments, these potential drawbacks can be overcome by using steepest descent or gradient vector techniques.

Steepest descent processing may be used to solve the problem of convergence that occurs in the Taylor series method. The convergence speed or the convergence of Taylor series processing in the GN may depend on the initial estimate co-ordinates. By using steepest descent processing, an initial estimate value may be determined that is close to the original value of the node so that the Taylor series processing converges. Steepest descent processing has advantages that include fast convergence, when the initial guess is far from the true value of the node.

By rewriting the Equation (8) it can be determined that:

φᵢ(x,y)=f_{i(x,y)}−d̂_{i+1,1}+ε_{i+1,1} i=1,2, . . . , M−1, (12)

where the module function for Equation 12 is given as

Φ(x,y)=Σᵢ₌₁^{N-1}[φᵢ(x,y)]².

Letting the initial estimate (guess) value to be at (x₀,y₀), φᵢ(x,y) should be translated such that a minimal value of Φ(x,y) is obtained. In some illustrative embodiments, Φ(x,y) is declined in the direction of steepest descent to obtain a minimum value.

The direction of the gradient vector of Φ(x,y) may be denoted by

$$G = {( \frac{δΦ}{δ x} , \frac{δΦ}{δ y} )}^{T}$$

By computing the gradient vectors at the point (x₀,y₀), the following may be obtained:

G₀=(g₁₀,g₂₀)^{T} (12)

In illustrative embodiments, the direction opposite to the gradient vector may be the direction of the steepest descent whose gradient value is denoted as −G₀. As such, the new location of the node may be obtained by subtracting the steepest gradient vector value, multiplied by a factor (λ) from the initial guess value. Thus it may be represented as:

x₁=x₀−λg₁₀, y₁=y₀−λg₂₀ (13)

where λ is the step-size parameter. Accordingly, the equation may be simplified as:

$$Φ ( {x}_{0} - λ {g}_{10 ,} {y}_{0} - {g}_{20} ) = {\sum }_{i = 1}^{N - 1} {{ϕ}_{i } ( {x}_{0} - λ {g}_{10 ,} {y}_{0} - {g}_{20} )}^{2} = \{ \begin{matrix}{\sum }_{i = 1}^{N - 1} {ϕ}_{i}^{2} - 2 λ {\sum }_{i = 1}^{N - 1} {ϕ}_{i} ( {g}_{10} \frac{\partial {ϕ}_{1}}{\partial x} + {g}_{20} \frac{\partial {ϕ}_{1}}{\partial y} ) + \\ {λ}^{2} {\sum }_{i = 1}^{N - 1} {{ϕ}_{i} ( {g}_{10} \frac{\partial {ϕ}_{i}}{\partial x} + {g}_{20} \frac{\partial {ϕ}_{i}}{\partial y} )}^{2} {( {g}_{10} \frac{\partial {ϕ}_{i}}{\partial x} + {g}_{20} \frac{\partial {ϕ}_{i}}{\partial y} )}^{2}\end{matrix} \} ( {x}_{0} , {y}_{0} )$$

In some illustrative embodiments, an appropriate value of λ may be chosen such that the value of −G₀ becomes minimum, thus optimizing it to be

$$Φ ( {x}_{1} , {y}_{1} ) \approx min \{ φ ( {x}_{0} - λ {g}_{10 ,} {y}_{0} - λ {g}_{20} ) \} . \\ So allowing \frac{d Φ}{d λ} = 0 \\ then \\ λ = [ \frac{{\sum }_{i = 1}^{M - 1} {ϕ}_{i} ( {g}_{10} \frac{\partial {ϕ}_{i}}{\partial x} + {g}_{20} \frac{\partial {ϕ}_{i}}{\partial y} )}{{\sum }_{i = 1}^{M - 1} {( {g}_{10} \frac{\partial {ϕ}_{i}}{\partial x} + {g}_{20} \frac{\partial {ϕ}_{i}}{\partial y} )}^{2}} ] ( {x}_{0} , {y}_{0} ) \qquad ( 14 )$$

By Substituting Equations (12) and (13) in Equation (14) a new position may be obtained of the node at (x₁,y₁). For a next iteration, the values of (x₁,y₁) may be substituted for the initial guess. These iterations will be repeated until the process gets a minimum value of Φ(x₁,y₁). In this way the guess value may be calculated to be close to the original value.

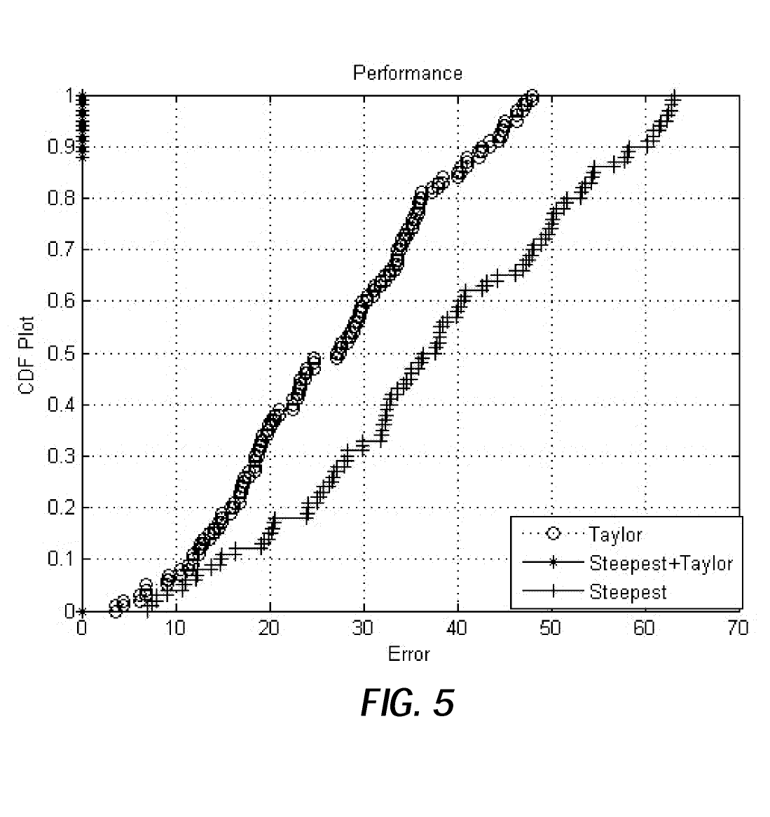

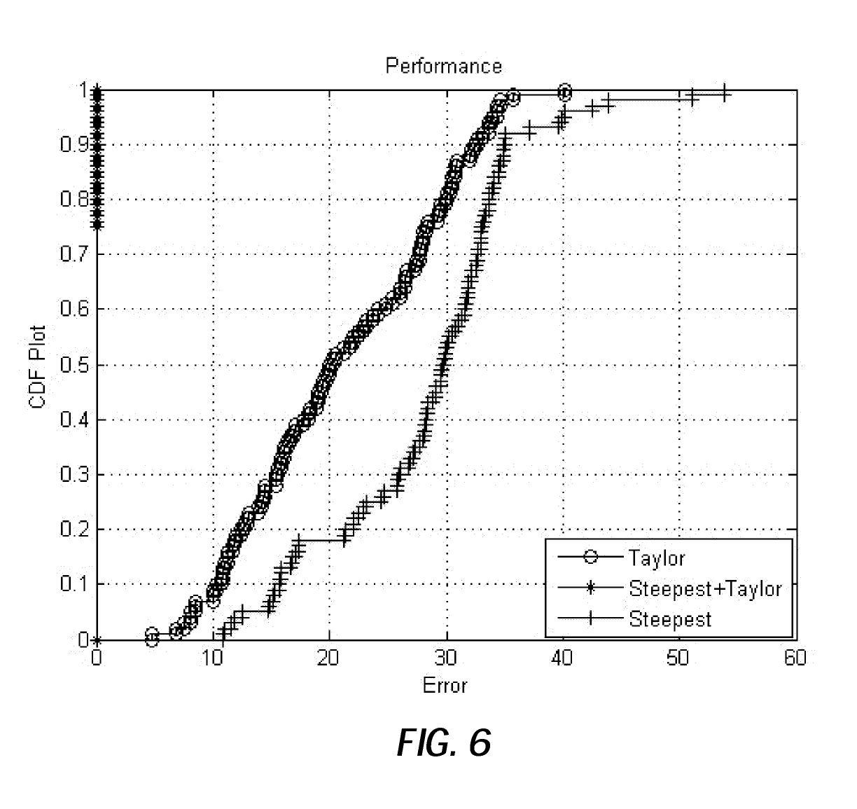

It can be appreciated by those skilled in the art that the Hybrid Optimizing Algorithm (HOA) disclosed herein provides accurate location estimates by performing, at an initial stage, steepest descent processing to get the initial estimate (guess) value close to the true value of the node, followed by Taylor series processing to get an accurate position of the node. As such, HOA tends to have better convergence, accuracy and efficiency. The example of FIG. 5 provides a simulated diagram showing a cumulative distribution function versus error for steepest descent, Taylor series and HOA (Steepest+Taylor) when three RN's (see FIGS. 1-2) are considered. The example of FIG. 6 provides a simulated diagram showing a cumulative distribution function versus error for steepest descent, Taylor series and HOA (Steepest+Taylor) when four RN's (see FIG. 1) are considered.

In some illustrative embodiments, multidimensional scaling techniques may be used for location determination. Multidimensional scaling processing as disclosed herein is a data analysis technique that may advantageously be applied to the wireless sensor network localization so it works like a centralized localization technique. In an embodiment, the location of the sensor nodes may be determined by a powerful base station, and may be a multi-step process. Initially, the proximity information or the pair-wise distance matrix may be collected. To obtain the pair-wise distances, the whole network may be flooded with message packets. Once the pair-wise distance matrix is obtained, the relative locations of the sensor nodes may be calculated and sent to the sensor nodes. If a minimum of three non-collinear anchor nodes are available then, by alignment procedure, the physical locations of these sensor nodes can be evaluated. While various forms of multidimensional scaling methods may be used, the present disclosure will focus on, without limitation, a classical multidimensional scaling method. Under this method, with the availability of all the pair-wise distances, a simple Eigen decomposition may yield the relative positions of the sensor nodes.

In some illustrative embodiments, classical multidimensional scaling may involve creating a distance matrix by collecting all the pair-wise distances of the sensor nodes in the network. Using the distance matrix, the location of the sensor is evaluated. For example, if T=[tᵢⱼ]_{n×2} denotes a true locations of n sensor nodes a the 2-dimensional system, then the distance matrix may be obtained by

dᵢⱼ(T)=(Σₐ₌₁²(tᵢₐ−tⱼₐ)²)² (1)

Defining H=TT′ then,

$$\begin{matrix}{{d}_{ij} ( T )}^{2} = \sum {t}_{ik}^{2} + \sum {t}_{ik}^{2} - 2 \sum {t}_{ik} {t}_{jk} \\ = {H}_{ii} + {H}_{jj} - 2 {H}_{ij}\end{matrix}$$

Centering the data at the true position matrix T without the loss of generality yields Σᵢ₌₁ⁿHᵢⱼ=0 and

$$\frac{1}{n} {\sum }_{i = 1}^{n} {d}_{ij}^{2} = \frac{1}{n} {\sum }_{i = 1}^{n} {H}_{ii} + {H}_{jj}$$

$$\frac{1}{n} {\sum }_{i = 1}^{n} {d}_{ij}^{2} = \frac{1}{n} {\sum }_{j = 1}^{n} {H}_{jj} + {H}_{ii}$$

$$\frac{1}{{n}^{2}} {\sum }_{i = 1}^{n} {\sum }_{j = 1}^{n} {d}_{ij}^{2} = \frac{2}{n} {\sum }_{j = 1}^{n} {H}_{ii}$$

$$Then , \begin{matrix}{H}_{ij} = [ {H}_{ii} + {H}_{jj} - \frac{1}{2} {d}_{ij}^{2} ] \\ = \frac{1}{2} [ \frac{1}{n} {\sum }_{i} {d}_{ij}^{2} + \frac{1}{n} {\sum }_{j} {d}_{ij}^{2} - {d}_{ij}^{2} - \frac{1}{{n}^{2}} {\sum }_{i} {\sum }_{j} {d}_{ij}^{2} ]\end{matrix}$$

From the above equations we deduce that H can be obtained with dᵢⱼ and since H=TT′ the H matrix is factorized using eigen-decomposition:

H=UVU′

where

U=[u₁,u₂, . . . uₙ] and

V=diag[v₁,v₂, . . . vₙ]

may produce

$$X = {UV}^{\frac{1}{2}} = [ {u}_{1} {v}_{1}^{\frac{1}{2}} , {u}_{2} {v}_{2}^{\frac{1}{2}} , … {u}_{n} {v}_{n}^{\frac{1}{2}} ]$$

$$and$$

$$H = {XX}^{′} .$$

Here, X may be different from T because X is n×n matrix whereas T is a 1×n matrix. In some illustrative embodiments, only the first two columns of the X matrix is considered in a 2-dimensional case. Thus, using the multidimensional scaling method, the relative positions of the sensor nodes may be obtained for a wireless sensor network.

In an illustrative embodiment, a classical multidimensional scaling method may be summarized as follows:
(1) Obtain the squared distance matrix D², where D=[dᵢⱼ]_{n×n}
(2) Compute J matrix such that J=I−e·e^{T}/n, where e=(1,1, . . . 1)
(3) Apply double centering to this matrix with

$$H = - \frac{1}{2} {JD}^{2} J .$$

(3) Factorizing H using eigen-decomposition yields H=UVU^{T}
(4) Depending on the number of dimensions of interest, select i Eigen values of Vᵢ and Uᵢ where Uᵢ is the first i columns of U matrix. For example i=2 in 2-D case.
   Thus, a coordinate matrix of classical multidimensional scaling may be

$$X = {U}_{i} {V}_{i}^{\frac{1}{2}}$$

In some illustrative embodiments, the pair-wise distances/distance matrix may be embodied as a similarity or dissimilarity matrix for the MDS processing, and may be obtained by flooding the network. As flooding may lead to power consumption, distance vector algorithms (among other techniques) may be advantageously used to control flooding and provide efficient services. Other techniques that can be used for pair-wise distance collection include, but are not limited to, Floyd's algorithm (also known as Floyd-Warshall algorithm) and Dijkstra's (shortest path) algorithm. The distance vector algorithms are preferred over them due to their efficiency and ability to utilize the positioning techniques.

In some illustrative embodiments, variants of distance vector algorithms may be used, such as distance vector-hop and distance vector-distance propagation. For distance vector-hop, the position of the node along with the hop count is propagated through the network. The distance between the nodes may be evaluated by multiplying the average hop distance value with the hop count. For distance vector-distance propagation, the distance may be propagated instead of the hop count value. Hop distance may be considered as the maximal range for direct communication for a sensor node. The far-away sensor nodes may communicate hop by hop, and the radio signal of the sensor node attenuates as it travels. In some cases, the nature of attenuation of the radio signal is exponential. These characteristic of the radio signal may be thought of as a principle of operation for received signal strength indication (RSSI). The signal strength decreases with the distance, therefore the distance between the nodes can be evaluated by calculating the strength of the transmitted signal at the receiver. Average hop distance may be the radius of the circle centering the sensor node.

To begin the pair-wise distance collection procedure, away sensor nodes which could be either anchor nodes or general nodes (nodes that do not know their location) should be initiated for broadcasting. The initiated sensor nodes may be referred to as source nodes. Each source node broadcast a message containing the node ID, location (in case of anchor node) and hop count (the hop count value is initialized to zero). The neighboring sensor nodes which are one hop distance away hear the broadcasted message from the source node and perform the following tasks: append their ID, increment the hop count by one and rebroadcasts the message. This process is repeated till all the sensor nodes in the network receive the source nodes' message. The sensor nodes in the network may ensure that duplication of the process is eliminated with the help of hop count value.

In certain illustrative embodiments, if the sensor node hears a broadcast message with a lower hop count value, then the message with the higher hop count value is discarded. Otherwise, the sensor node appends its ID, increment the hop count value by one and rebroadcast the message. All the sensor nodes may keep track of their routing information to the source node. The distance between a pair of sensors may be calculated by multiplying the average hop distance with the hop count value. If a broadcast form one anchor node is heard by another anchor node, then the average hop distance value is calculated and later when this anchor node is initiated for broadcast, it will include this average distance value in the broadcast message. Thus, the pair-wise distances in the sensor network are obtained. This pair-wise distance matrix (or “distance matrix”) is fed as input to the MDS method to perform localization.

In some illustrative embodiments, the accuracy of the distance matrix can be improved by replacing the RSSI with other positioning methods such as the TOA, TDOA and TFDA methods described herein. Although obtaining a distance matrix using RSSI may be done conventionally, it has certain disadvantages, at least partly due to RSSI processing dependency upon a signal's magnitude, and is affected easily by its environment and may be susceptible to a multitude of effects, including multipath fading. Also, an error in the assumption of the average hop distance value will propagate throughout the network providing further error in the distance matrix. To overcome such issues, the present disclosure provides the use of TOA, TDOA or TFDA in various embodiments described herein.

In embodiments utilizing TOA processing for obtaining the distance matrix, the broadcast message may contain the source node ID, location (in case of anchor node), hop count initialized to zero, and the time stamp at which the signal is transmitted. The sensor node upon hearing the broadcasted message, it will append its ID and increment the hop count by one and rebroadcast the message. The time of arrival of the signal at the sensor node helps in determining the range or the distance between the nodes. In this case, the clocks should be synchronized. To mitigate the need for clock synchronization, TDOA can be used.

In some illustrative embodiments, a plurality of ways may be used to implement TDOA. One illustrative method comprises the use of two different signals that are transmitted from the source node. Because of the difference in the characteristics of the signals, they may propagate with different velocities. This method of implementation eliminates the need for clock synchronization but on the other hand, it may increase the complexity of the circuit in terms of hardware requirements. Another illustrative TDOA method comprises having the sensor nodes in the network listen to the messages from all the source nodes and calculate the time difference in the arrival of those signals. This time difference may correspond to the range. Thus, the distance matrix may be obtained using TDOA positioning.

In some illustrative embodiments, positioning may be accomplished using TFDA techniques, where the clock synchronization problem can be eliminated as the difference in frequency is calculated to obtain the distance matrix. Also, this technique may be more reliable due to its robustness to the environmental factors. The cost of implementation of this technique is minimal and accuracy achieved is high. To obtain the distance matrix using TFDA positioning, the source node may broadcast a message containing its node ID, location (if the source node is anchor node), and FMCW signal and hop count initialized to zero. The sensor node, upon hearing the broadcasted message, will append its ID, FMCW signal and increment the hop count by one and rebroadcast the message into the network. Each node maintains a table containing all the received FMCW signals. The TFDA is then applied to the table to obtain the pair-wise distance matrix.

In some illustrative embodiments, obtaining an accurate distance matrix is one task. Another task may be to determine the number of pair-wise distances needed. If a network consists of ‘n’ sensor nodes, then there exists n*(n−1) pair-wise distances. If all these pair-wise distances are provided, then one can obtain highly accurate locations of the nodes. In practice, all the pair-wise distances may not be available. Nevertheless, studies have indicated that the availability of a minimum of 10% of the pair-wise distances would also yield highly accurate results. In general, depending upon the position of the source node in the network, the connectivity among the nodes, and the performance of the positioning technique, a given source node may collect about 3%-8% of the pair-wise distances. By increasing the number of source nodes, this may result into flooding the network, which in turn leads to power consumption. Also, the pair-wise distance collection may not be linearly related to the number of source nodes. If two source nodes are situated closely, then there is a probability that many pair-wise distances collected by both the source nodes are common, leading to the availability of less number of pair-wise distances. Therefore, while initiating the sensor nodes in a network, far away sensor nodes should be initiated to collect more pair-wise distances as sensor nodes situated at the center of the network tend to collect less number of distances. Accordingly, collected pair-wise distances may be subjected to multidimensional scaling (MDS) processing, which may provide relative locations of the sensor nodes. In order to obtain the physical/true location of the nodes, alignment procedures may be applied.

For physical position calculation, a number of applications may be applied in various embodiments that work on the availability of the relative locations of the sensor nodes. To obtain the true positions from the relative positions of the nodes, MDS requires just three anchor nodes. It is to be noted that to determine the locations in 2-dimensional space three anchor nodes are sufficient whereas for 3-dimensional space at least four anchor nodes are required. According to the alignment technique, the relative positions obtained by the MDS, are shifted, rotated and reflected with respect to the anchor nodes to provide the physical/true locations of the nodes. The procedure is discussed below.

In an illustrative embodiment, R=[rᵢⱼ]_{2×n}=(R₁, R₂, R₃, . . . , Rₙ) represents the relative positions of the n sensor nodes in the 2-dimensional space, and T=[tᵢⱼ]_{2×n}=(T₁, T₂, T₃, . . . , Tₙ) denotes the true locations of those sensor nodes in 2-dimensional space. Allowing nodes 1, 2, 3 be the anchor nodes, a vector Rᵢ may be shifted to Rᵢ⁽¹⁾ by Rᵢ⁽¹⁾=Rᵢ+X, implies X=Rᵢ⁽¹⁾−Rᵢ. It may be rotated counter clockwise through an angle α to Rᵢ⁽²⁾=Q₁Rᵢ, where

$${Q}_{1} = [ \begin{matrix}cos ( α ) & - sin ( α ) \\ sin ( α ) & cos ( α )\end{matrix} ]$$

and it may be reflected across the line,

$$S = ( \begin{matrix}cos ( β / 2 ) \\ sin ( β / 2 )\end{matrix} )$$

$$to$$

$${R}_{i}^{( 3 )} = {Q}_{2} {R}_{i} , \\ where$$

$${Q}_{2} = [ \begin{matrix}cos ( β ) & sin ( β ) \\ sin ( β ) & - cos ( β )\end{matrix} ] .$$

The data available for alignment process is the R matrix from MDS and physical position of three anchor nodes T₁, T₂, T₃. With the help available data, (T₄, T₅, . . . , Tₙ) may be computed. Using the shifting, rotating and reflecting properties discussed above, it can be determined that

(T₁−T₁,T₂−T₁,T₃−T₁)=Q₁Q₂(R₁−R₁,R₂−R₁,R₃−R₁)

and, as the values of T₁, T₂, T₃ and R₁, R₂, R₃ known,

Q=Q₁Q₂=(T₁−T₁,T₂−T₁,T₃−T₁)/(R₁−R₁,R₂−R₁,R₃−R₁).

After obtaining Q value, (T₄, T₅, . . . , Tₙ) can be evaluated as given below:

(T₄−T₁,T₅−T₁, . . . , Tₙ−T₁)=Q(R₄−R₁,R₅−R₁, . . . , Rₙ−R₁)(T₄,T₅, . . . , Tₙ)=Q(R₄−R₁,R₅−R₁, . . . , Rₙ−R₁)+(T₁,T₁, . . . , T₁)

Thus, the physical/true location of all the nodes in the network is obtained.

MDS technique is found to be very accurate and efficient and offers many advantages over the other existing methods. Classical multidimensional scaling techniques are easier to implement, and computationally less complex. The accuracy of localization can be controlled by controlling the flooding in the network. This method can also be applied to very large and error prone regions too. The large area is divided into small regions and MDS is applied on the small areas. The result of these small regions is combined to obtain the whole area's data. Therefore, MDS is also suitable for distributed localization as well.

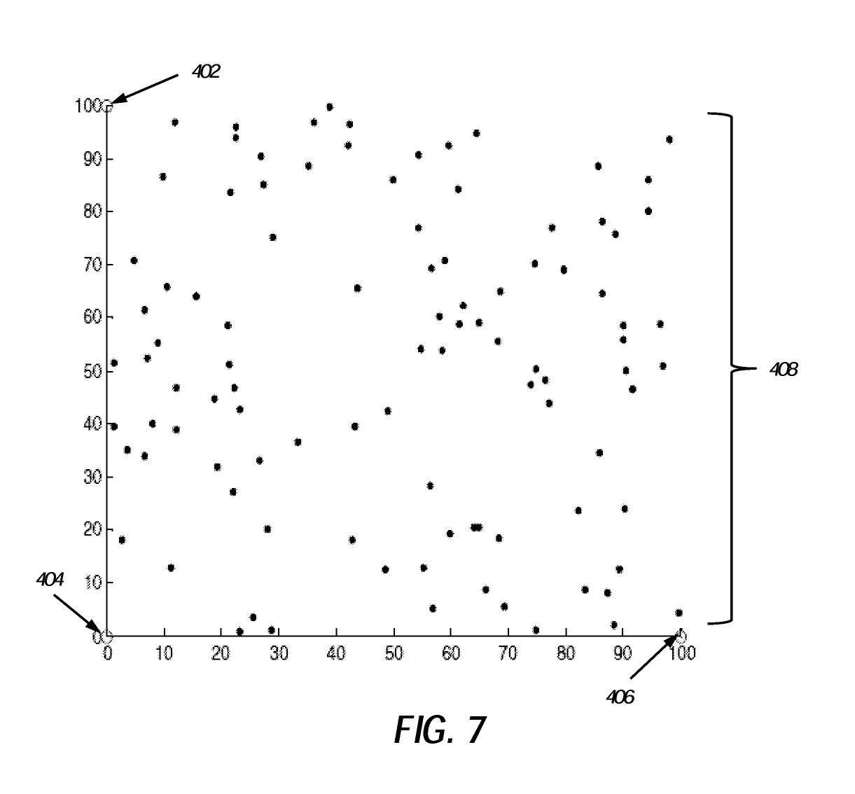

FIG. 7 illustrates an illustrative system model demonstrating performance of the localization algorithms described herein. The system represents a hundred randomly deployed sensor nodes 408 and three anchor nodes 402-406. The anchor nodes 402-408 in this example are located at (0, 0), (100, 0) and (0, 100). In an illustrative embodiment, the black dots (408) represent the randomly placed sensor nodes whose locations are to be determined. Whereas the peripheral circles (402-406) represent anchor nodes. To determine the locations of the unknown nodes, the system is subjected to MDS localization process. Ignoring the presence of anchor nodes, MDS provides the relative positions of the sensor nodes, which illustrates one advantage of using MDS localization technique: even in the absence of anchor nodes or reference nodes, it provides relative locations of the unknown sensor nodes.

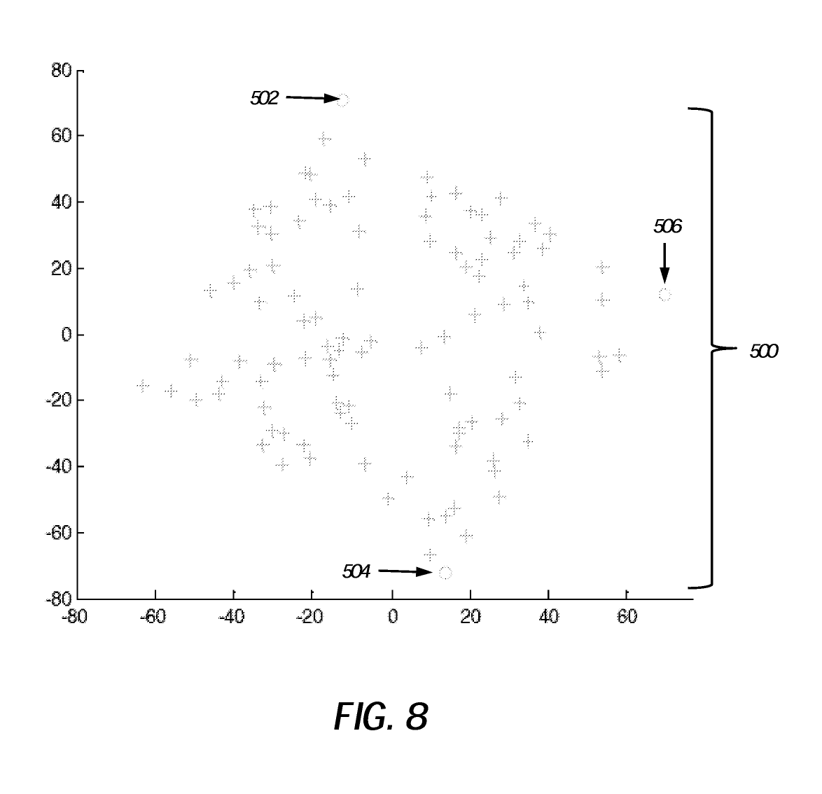

The embodiment of FIG. 8 shows the relative sensor node distribution in 2-dimensional space given by MDS. Aligning the relative positions of the anchor nodes (502-506) obtained using MDS with the true locations will produce the true locations of all the sensor nodes 500. As multidimensional scaling processing requires data to perform localization, the data need not necessarily be a distance matrix, but can be a proximity matrix. The use of a distance matrix involves the positioning algorithms leading to increased accuracy and performance of MDS. Therefore distance matrix is obtained and is fed to the MDS as input.

When implemented, the present disclosure provides increased accuracy, speed, and efficiency in determining wireless positioning over the prior art. In the foregoing detailed description, it can be seen that various features are grouped together in individual embodiments for the purpose of brevity in the disclosure. This method of disclosure is not to be interpreted as reflecting an intention that the subsequently claimed embodiments require more features than are expressly recited in each claim.

Further, the descriptions of the disclosure are provided to enable any person skilled in the art to make or use the disclosed embodiments. Various modifications to the disclosure will be readily apparent to those of ordinary in the pertinent art, and the generic principles defined herein may be applied to other variations without departing from the spirit or scope of the disclosure. Thus, the disclosure is not intended to be limited to the examples and designs described herein, but rather are to be accorded the widest scope consistent with the principles and novel features disclosed herein. That is, the claims which follow are to be accorded their respective broadest scope in light of the exemplary disclosure made herein.

What is claimed is:

1. A method for wirelessly determining a location of a general node configured to communicate with a plurality of reference nodes, comprising the steps of:
receiving, in the general node, signals from each of the plurality of reference nodes, wherein at least one of the received signals comprises a linear frequency-modulated signal;
processing the received signals in the general node, wherein the processing comprises the steps of determining range differences for the received signals, said range differences comprising time and frequency differences among at least some of the received signals;
estimating a location value in the general node, wherein the location value is based on a hyperbolic characteristic of the processed signals; and
converging the estimated location value to determine a location value for the general node.

2. The method of claim 1, wherein the linear frequency-modulated signal comprises a linear frequency-modulated continuous wave (FMCW) signal.

3. The method of claim 1, wherein at least some of the received signals are received simultaneously in the general node.

4. The method of claim 1, wherein range differences are determined by producing a local signal in the general node and correlating the local signal to each of the received signals.

5. The method of claim 4, wherein the correlating of the local signal to each of the received signals is used to determine time differences and to extract a first received signal.

6. The method of claim 5, wherein the first received signal is mixed with the other received signals, and wherein the mixed signal is filtered and transformed to determine the frequency differences.

7. The method of claim 6, wherein the transform comprises a Fast Fourier Transform (FFT).

8. The method of claim 1, wherein the hyperbolic characteristic is determined from a Taylor iterative process.

9. The method of claim 1, wherein at least one of the received signals comprises location and identification data relating to each of the reference nodes

10. A general node, configured to determine a location for the general node, comprising:
a processing apparatus; and
communications, operatively coupled to the processing apparatus, said communications being configured to communicate with a plurality of reference nodes, wherein the communications is configured to receive signals from each of a plurality of reference nodes, and wherein at least one of the received signals comprises a linear frequency-modulated signal;
wherein the processing apparatus is configured to process the received signals to determine range differences for the received signals, said range differences comprising time and frequency differences among at least some of the received signals,
and wherein the processing apparatus is configured to estimate a location value in the general node, wherein the location value is based on a hyperbolic characteristic of the processed signals and converge the estimated location value to determine a location value for the general node.

11. The general node of claim 10, wherein the linear frequency-modulated signal comprises a linear frequency-modulated continuous wave (FMCW) signal.

12. The general node of claim 10, wherein at least some of the received signals are received simultaneously in the communications.

13. The general node of claim 10, further comprising an oscillator operatively coupled to the processing apparatus, wherein range differences are determined in the processing apparatus by producing a local signal via the oscillator and correlating the local signal to each of the received signals.

14. The general node of claim 13, wherein the processing apparatus is configured to correlate the local signal to each of the received signals to determine time differences and to extract a first received signal.

15. The general node of claim 14, wherein the processing apparatus comprises a mixer and a filtering apparatus, said mixer being configured to mix the first received signal with the other received signals, and wherein the mixed signal is filtered via the filtering apparatus, said processing apparatus being configured to transform the filtered signal to determine frequency differences.

16. The general node of claim 15, wherein the transform comprises a Fast Fourier Transform (FFT).

17. The general node of claim 10, wherein the hyperbolic characteristic is determined from a Taylor iterative process.

18. The general node of claim 10, wherein the signal comprises location and identification data relating to each of the reference nodes.

19. A computer program product, comprising a tangible, non-transitory, computer usable medium having a computer readable program code embodied therein, said computer readable program code adapted to be executed to implement a method for wirelessly determining a location of a general node configured to communicate with a plurality of reference nodes, comprising:
receiving, in the general node, signals from each of the plurality of reference nodes, wherein at least one of the received signals comprises a linear frequency-modulated signal;
processing the received signals in the general node, wherein the processing comprises the steps of determining range differences for the received signals, said range differences comprising time and frequency differences among at least some of the received signals;
estimating a location value in the general node, wherein the location value is based on a hyperbolic characteristic of the processed signals; and
converging the estimated location value to determine a location value for the general node.

20. The computer program product of claim 19, wherein at least some of the received signals are received simultaneously in the general node.
